(19) United States
(12) Patent Application Publication
(10) Pub. No.: US 2026/0238377 A1
(43) Pub. Date: Aug. 13, 2026

(54) SIGNALING PROCEDURES FOR CONCATENATED CHANNEL CODES

(71) Applicant: Lenovo (United States) Inc., Morrisville, NC (US)

(72) Inventors: Abir BEN HADJ FREDJ, Frankfurt am Main (DE); Razvan-Andrei STOICA, Essen (DE)

(21) Appl. No.: 19/048,312

(22) Filed: Feb. 7, 2025

(51) Int. Cl. H04L 1/00; H04W 72/1268; H04W 72/231; H04W 76/20

(52) U.S. Cl. CPC H04L 1/0003; H04L 1/0061; H04W 72/1268; H04W 72/231; H04W 76/20

(57) ABSTRACT

Various aspects of the present disclosure relate to signaling procedures associated with concatenated channel codes, such as interleaved channel codes. The signaling procedures may support or enhance the signaling of channel codes, such as via physical layer signaling and/or radio resource control (RRC) signaling. For example, different modulation and coding scheme (MCS) tables may be associated with component codes of a concatenated channel code, such as a first MCS table for an inner code and a second MCS table for an outer code. Further, interleaving patterns and/or puncturing patterns within the concatenated channel codes may be configured via the RRC signaling.

### TECHNICAL FIELD

The present disclosure relates to wireless communications, and more specifically to signaling procedures for concatenated channel codes.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

For example, 6G aims to provide connectivity for services and applications across many vertical domains including factory automation applications, tactile internet services autonomous driving services, extended reality (XR) applications (e.g., virtual reality (VR) and augmented reality (AR) applications), medical applications, and many others. To effectively support these vertical applications, a wireless communications system may implement stringent requirements regarding end-to-end transmission latencies, data throughput, ultra-reliability, packet size flexibility, communications, availability, and so on.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that support signaling procedures for serial and/or parallel concatenation of channel codes.

A network entity for wireless communication is described. The network entity may be configured to, capable of, or operable to perform one or more operations as described herein. For example, the network entity may comprise at least one memory and at least one processor coupled with the at least one memory and configured to cause the network entity to generate a configuration of multiple modulation and coding schemes (MCSs), wherein the configuration associates each of the multiple MCSs with one or more component codes of multiple concatenated forward error correction (FEC) codes, and transmit the configuration to a UE via physical layer or radio resource control (RRC) signaling.

A method performed or performable by the network entity is described. The method may comprise generating a configuration of multiple MCSs, wherein the configuration associates each of the multiple MCSs with one or more component codes of multiple concatenated FEC codes and transmitting the configuration to a UE via physical layer or RRC signaling.

In some implementations of the network entity and method described herein, the network entity and method may further be configured to, capable of, performed, performable, or operable to define, for the multiple concatenated FEC codes, a first MCS table for an inner code and a second MCS table for an outer code.

In some implementations of the network entity and method described herein, the network entity and method may further be configured to, capable of, performed, performable, or operable to select the first MCS table and the second MCS table based on channel conditions of a network associated with the network entity, spectral efficiency for the network, or target requirements for a service support by the network.

In some implementations of the network entity and method described herein, the network entity and method may further be configured to, capable of, performed, performable, or operable to transmit the configuration of multiple MCSs to the UE via separate downlink control information (DCI) formats.

In some implementations of the network entity and method described herein, the DCI format comprises additional MCS fields, including a first additional MCS field associated with inner codes of one or more channel codes, and a second additional MCS field associated with outer codes of the one or more channel codes.

In some implementations of the network entity and method described herein, the DCI format comprises an MCS field that is extended to indicate a code rate associated with an inner code of the one or more channel codes and a code rate associated with an outer code of the one or more channel codes.

In some implementations of the network entity and method described herein, the separate DCI formats include modulation and coding information for the multiple concatenated FEC codes.

In some implementations of the network entity and method described herein, the separate DCI formats include a first DCI format associated with inner codes of the one or more channel codes and a second DCI format associated with outer codes of the one or more channel codes.

In some implementations of the network entity and method described herein, the network entity and method may further be configured to, capable of, performed, performable, or operable to transmit the configuration to the UE via the RRC signaling.

In some implementations of the network entity and method described herein, the network entity and method may further be configured to, capable of, performed, performable, or operable to transmit, via physical downlink shared channel (PDSCH)-config and physical uplink shared channel scheduling (PUSCH)-config information elements (IEs) of the RRC signaling, the multiple concatenated FEC codes to the UE in a semi-static manner.

In some implementations of the network entity and method described herein, different radio network temporary identifiers (RNTIs) are associated with different MCSs of the configuration.

In some implementations of the network entity and method described herein, the network entity and method may further be configured to, capable of, performed, performable, or operable to transmit to the UE, via the RRC signaling, one or more interleaving patterns applied to an output of the multiple concatenated FEC codes.

In some implementations of the network entity and method described herein, the network entity and method may further be configured to, capable of, performed, performable, or operable to transmit, via PDSCH-config and PUSCH-config IEs of the RRC signaling, puncturing parameters associated with the multiple concatenated FEC codes.

In some implementations of the network entity and method described herein, the multiple concatenated FEC codes include quasi-cyclic, low-density, parity-check (QS-LDPC) codes, polar codes, Bose-Chaudhuri-Hocquenghem (BCH) codes, or combinations thereof.

A network entity for wireless communication is described. The network entity may be configured to, capable of, or operable to perform one or more operations as described herein. For example, the network entity may comprise at least one memory and at least one processor coupled with the at least one memory and configured to cause the network entity to generate a configuration for one or more interleaver patterns applied to an output of inner codes or an input of the inner codes and outer codes of concatenated FEC codes and transmit the configuration to a UE via RRC signaling.

A method performed or performable by the network entity is described. The method may comprise generating a configuration for one or more interleaver patterns applied to an output of inner codes or an input of the inner codes and outer codes of concatenated FEC codes and transmitting the configuration to a UE via RRC signaling.

In some implementations of the network entity and method described herein, the network entity and method may further be configured to, capable of, performed, performable, or operable to generate the configuration to indicate one or more puncturing procedures applied to the inner codes or the outer codes of the concatenated FEC codes.

In some implementations of the network entity and method described herein, the network entity and method may further be configured to, capable of, performed, performable, or operable to transmit the configuration to the UE via PDSCH-config and PUSCH-config information elements IEs of the RRC signaling.

A UE for wireless communication is described. The UE may be configured to, capable of, or operable to perform one or more operations as described herein. For example, the UE may comprise at least one memory and at least one processor coupled with the at least one memory and configured to cause the UE to receive, from a network entity via physical layer or RRC signaling, a configuration of multiple MCSs, wherein the configuration associates each of the multiple MCSs with one or more component codes of multiple concatenated FEC codes, and communicate in accordance with the configuration.

A method performed or performable by the UE is described. The method may comprise receiving, from a network entity via physical layer or RRC signaling, a configuration of multiple MCSs, wherein the configuration associates each of the multiple MCSs with one or more component codes of multiple concatenated FEC codes and communicating in accordance with the configuration.

In some implementations of the NE and method described herein, the NE and method may further be configured to, capable of, performed, performable, or operable to receive the configuration via separate DCI formats.

A UE for wireless communication is described. The UE may be configured to, capable of, or operable to perform one or more operations as described herein. For example, the UE may comprise at least one memory and at least one processor coupled with the at least one memory and configured to cause the UE to receive, from a network entity via RRC signaling, a configuration for one or more interleaver patterns applied to an output of inner codes or an input of the inner codes and outer codes of concatenated FEC codes, and communicate in accordance with the configuration.

A method performed or performable by the UE is described. The method may comprise receiving, from a network entity via RRC signaling, a configuration for one or more interleaver patterns applied to an output of inner codes or an input of the inner codes and outer codes of concatenated FEC codes and communicating in accordance with the configuration.

### BRIEF DESCRIPTION OF THE DRAWINGS

FIG. 1 illustrates an example of a wireless communications system in accordance with aspects of the present disclosure.

FIG. 2 illustrates an example of signaling a configuration of multiple MCSs between an NE and a UE in accordance with aspects of the present disclosure.

FIG. 3 illustrates an example of signaling a configuration of interleaver patterns between an NE and a UE in accordance with aspects of the present disclosure.

FIG. 4 illustrates an example of a UE in accordance with aspects of the present disclosure.

FIG. 5 illustrates an example of a processor in accordance with aspects of the present disclosure.

FIG. 6 illustrates an example of a network equipment (NE) in accordance with aspects of the present disclosure.

FIG. 7 illustrates a flowchart of a method performed by an NE in accordance with aspects of the present disclosure.

FIG. 8 illustrates a flowchart of a method performed by an NE in accordance with aspects of the present disclosure.

FIG. 9 illustrates a flowchart of a method performed by a UE in accordance with aspects of the present disclosure.

FIG. 10 illustrates a flowchart of a method performed by a UE in accordance with aspects of the present disclosure.

### DETAILED DESCRIPTION

A wireless communications system relies on channel codes when performing error detection and correction for data transmitted over a network. For example, a network supporting the 5G radio access technology employs low density parity check (LDPC) codes for transmissions over data channels and cyclic redundancy check (CRC)-aided polar codes for signaling over control channels.

At large block lengths, the performance of LDPC codes can be estimated using asymptotic techniques (e.g., density evolution). However, at finite code lengths, LDPC codes have a limited usefulness due to a lack of understanding of the dynamics of iterative decoding algorithm, leading to the use of the polar codes for control channels.

While the use of two different codes has been effective for 5G networks, 6G networks (or certain services/applications that may be supported in 6G) may benefit from a unified channel coding framework. However, the channel code should exhibit a low block error rate (BLER) for both large and finite block lengths balanced by a flexible implementation to facilitate different key performance indicators (KPIs) for the supported applications and services.

For example, a unified channel coding framework can avoid certain issues of implementation, such as drawbacks associated with additional hardware implementations, large power consumption, chip layouts, backward/forward capabilities for standards, and other drawbacks. Thus, a wireless communications system may benefit greatly from employing one of the 5G channel codes as a unified code for 6G network.

The systems and methods described herein introduce signaling procedures associated with concatenated channel codes, such as interleaved concatenated channel codes. The signaling procedures may support or enhance the signaling of channel codes, such as via physical layer signaling (e.g., DCI and different associated RNTIs) and/or RRC signaling (e.g., via the configuration of PDSCH-config and/or PUSCH-config IEs).

For example, different MCS tables may be associated with component codes of a concatenated channel code, such as a first MCS table for an inner code and a second MCS table for an outer code. The MCS tables may represent target code rates for different modulation schemes. Further, interleaving patterns and/or puncturing patterns within the concatenated channel codes may be configured via the RRC signaling. Thus, the signaling procedures may enable the configuration of the transmitted concatenated codes between devices (e.g., a UE and a base station), enabling a network to utilize and/or support a unified channel coding framework, among other benefits.

Aspects of the present disclosure are described in the context of a wireless communications system.

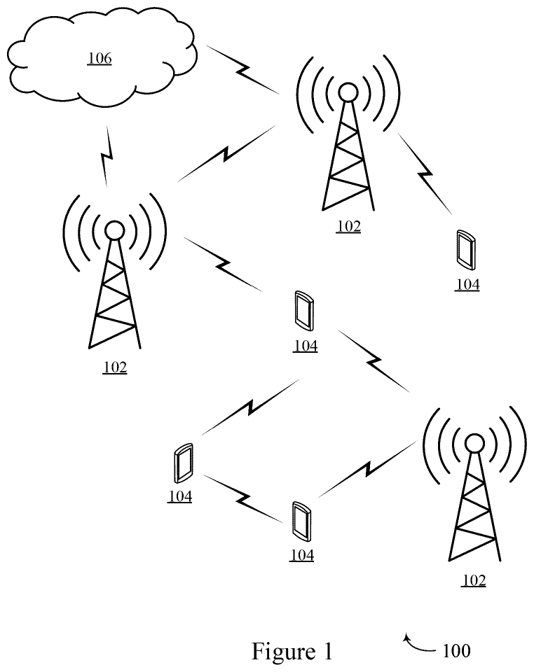

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

As described herein, the wireless communications system 100 may introduce mechanisms and/or procedures for signaling concatenated channel codes, such as interleaved concatenated channel codes. In some cases, a concatenated channel code may be a quasi-cyclic low-density parity-check (QC-LDPC) code, which includes two or more component codes (e.g., inner codes and outer codes). For example, the concatenation of an QC-LDPC inner code, or [symbol] ᵢₙ {n₁, k₁, R₁}, and an QC-LDPC outer code, or [symbol] ₒᵤₜ {n₂, k₁, R₂}, is a QC-LDPC code, or [symbol] _{conct} {n₁n₂, R₁R₂}, where nᵢ is a code length, k₁ is a code dimension, and Rᵢ is a code rate i∈{1,2}. The inner code may have a high code rate (e.g., close to 1) and the outer code may be selected as a rate-compatible code (e.g., a flexible or adaptable code rate). Alternatively, the outer code may have the high code rate (e.g., close to 1), while the inner code is rate compatible.

The signaling procedures may support or enhance the signaling of channel codes, such as via physical layer signaling (e.g., DCI and different associated RNTIs) and/or RRC signaling (e.g., via the configuration of PDSCH-config and/or PUSCH-config IEs). As described herein, the channel codes may include interleaving patterns and/or puncturing patterns associated with component codes of the channel codes. Thus, the signaling procedures may enable the signaling of the interleaving patterns and/or the puncturing patterns (e.g., configured by higher layers via RRC signaling in a semi-persistent manner).

For examples, the signaling may include MCS configuration details or information associated with the channel codes, the component codes, and/or the interleaving/puncturing patterns. The MCS configuration details may be associated with concatenated FEC codes, such as QC-LDPC concatenated codes (e.g., in a serial or parallel manner), Bose-Chaudhuri-Hocquenghem (BCH) codes, polar codes, and so on.

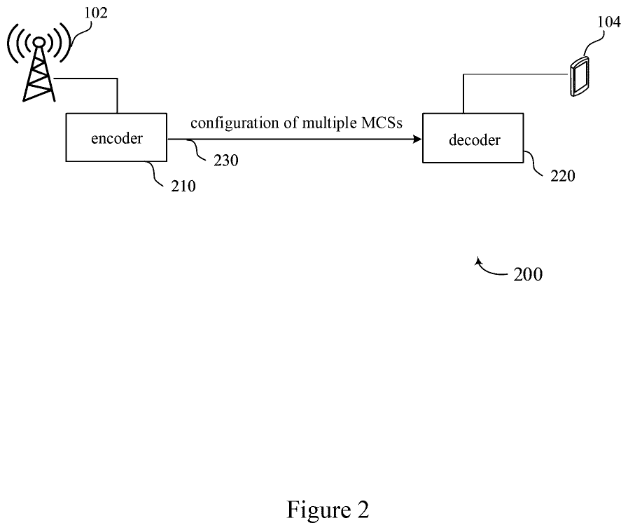

FIG. 2 illustrates an example of signaling 200 a configuration of multiple MCSs between an NE and a UE in accordance with aspects of the present disclosure. For example, an encoder 210 associated with a base station (the NE 102) may encode one or more data blocks as one or more concatenated codes. The encoder 210 may utilize DCI (or other physical layer signaling) and/or RRC signaling to transmit a configuration of multiple MCSs 230, associated with the concatenated codes, to a decoder 220 associated with the UE 104.

Thus, the NE 102 may be a transmitter of the configuration of multiple MCSs 230 and the UE 104 is a receiver of the configuration of multiple MCSs 230. In some cases, the UE 104 may be the transmitter of the configuration of multiple MCSs 230 and the NE 102 is the receiver of the configuration of multiple MCSs 230.

In some embodiments, the DCI may include an MCS field related to any or all component codes of a concatenated code (e.g., a component code 1, a component code 2 . . . component code N (where N>2). The same MCS field within the DCI may include different code rates, R₁, R₂, . . . , R_{N}, associated with the component inner and outer codes, as well as different or similar modulation schemes. For example, the DCI may be extended to accommodate a larger MCS bits sequence (e.g., more than 5 bits are allocated to the MCS field to include more information about the concatenated codes).

In some embodiments, the DCI may include more than one MCS field, where each MCS configuration correspond to different component codes. For example, N MCS fields are added to a DCI format. The length of the DCI may depend on the number of concatenated component codes (e.g., when two LDPC component codes are part of a concatenated code, two MCS configurations are included in a DCI format 1-0 and a DCI format 1-1). The remaining bits, allocated to the MCS fields that are associated with component codes N (N>2), are zeroed. Thus, the first two MCS fields may be fixed and associated with a k number of bits within the DCI. The other MCS fields may be indicated as optional and added when more than two component codes are part of a concatenated code.

Tables 1 and 2 present different MCS configurations
of DCI format 1-1, as follows:

| Field (Item) | Bits and Description |
|---|---|
| Carrier indicator | 0, 3 |
| Identifier for DCI format | 1 |
| Bandwidth part indicator | 0, 1, 2 |
| Frequency domain resource assignment | Variable |
| Modulation and coding scheme [TB1] | Variable |
| New data indicator [TB1] | 1 |
| Redundancy version [TB1] | 2 |

TABLE 1
a first option of a MCS configuration in the DCI format 1-1

| Field (Item) | Bits and Description |
|---|---|
| Carrier indicator | 0, 3 |
| Identifier for DCI format | 1 |
| Bandwidth part indicator | 0, 1, 2 |
| Frequency domain resource assignment | Variable |
| Modulation and coding scheme [MCS1] | 5 |
| Modulation and coding scheme [MCS2] | 5 |
| Modulation and coding scheme [MCS3] | Optional |
| New data indicator [TB1] | 1 |
| Redundancy version [TB1] | 2 |

### Table 2: A Second Option of a MCS Configuration in the DCI Format 1-1

In some embodiments, the DCI may include, as part of the MCS field, the information about the coding scheme corresponding to the resulting code of the concatenation. For example, the code rate signaled within the DCI may correspond to R_{P}=R₁R₂, where R₁ is the code rate of the outer code and R₂ is the code rate of the inner code. The UE 104, may, based on the configured code rate, determine the code rates corresponding to each of the concatenated codes.

In some cases, the UE 104 (or another configured device or entity), may be configured via RRC signaling (or other signaling) with a fixed high code rate corresponding to the outer codes and/or the inner codes. The inner code rate may be determined based on the desired code rate indicated within the MCS field of the DCI control information.

In some cases, the UE 104 may include or store a standardized lookup table associated with each of the inner and outer codes. The lookup table may enable the UE 104 to determine the code rates of the different concatenated codes, based on the information received within the DCI field MCS. Further, the DCI may be modified, as described herein, to include a change indicator field that explicitly indicates a particular modification of one or more MCS factors. For example, the change indication field may include information about an MCS table index (e.g., when a code rate is changed to a next code rate, the MCS index with the field is incremented).

The network (e.g., the NE 102) may be configured to populate the change indicator field and transmit the control information. The UE 104 may be configured to receive the control information and derive a modification of one or more MCS factors based on the populated change indicator field.

In some embodiments, different DCI formats associated with the inner and outer encoders may be configured via RRC signaling. For example, a first DCI format (e.g., DCI 1_1) is associated with an inner encoder configuration and a second DCI format (e.g., DCI 1_2) is associated with MCS signaling of the outer codes. The DCI formats may be determined and associated with the corresponding DCI using higher layer signaling. For example, a separate RRC signaling may configure each of the DCIs. As another example, different RNTIs may be associated with each of the DCI formats assigned to each of the component codes.

In some embodiments, different MCS tables are defined for each component code. The DCI may signal a reference to the corresponding MCS table associated with each component code. For example, a first MCS table may exclusively include code rates supported by an LDPC inner codes and each corresponding modulation scheme and a second MCS table may exclusively include the code rates associated with the LDPC outer codes and the corresponding modulation scheme.

In such cases, the modulation scheme corresponding with the outer code may be used by a receiver (e.g., the UE 104) to detect the received symbols. For example, the modulation scheme corresponding to the rates generated from different combination of rates within each of the MCS tables may be tabulated in another MCS table. The UE 104 may consider the reference of the MCS table to identify the corresponding modulation scheme associated with the rate of the concatenated code. The different MCS table references are signaled to the UE 104 within the DCI. In some cases, different MCS tables are associated with different inner and outer codes where a high spectral efficiency is guaranteed. In some cases, MCS tables associated with a low spectral efficiency for both inner and outer codes are defined to ensure a suitable or enhanced performance for different use cases, UE capabilities, and/or channel conditions.

In some embodiments, the MCS of the concatenated/product code may be configured via RRC signaling in a semi-static or semi-persistent manner, such as within the PDSCH-config and the PUSCH-config IEs. An encoder may be configured with the code rate and modulation order of the equivalent code of concatenated codes. The DCI formats 1_0 and 1_1 may be used to signal the MCSs tables of the inner and outer codes. For example, different RNTIs are associated with each MCS table and with each component code (e.g., the inner or outer codes).

In some embodiments, the UE 104 may be semi-statically configured with different MCSs associated with one or more channel codes that represent the inner and outer codes of a serial and/or parallel concatenation via RRC signaling. Based on varying channel conditions, different MCS configurations may be signaled to the UE 104 using different DCI MCS fields and different RNTIs, to ensure radio link adaptation.

An example PDSCH-config IE is as follows:

-- ASN1START
-- TAG-PDSCH-CONFIG-START
PDSCH-Config::= SEQUENCE
{dataScramblingIdentityPDSCH INTEGER (0...1023) OPTIONAL,
dmrs-DownlinkForPDSCH-MappingTypeA
SetupRelease {DMRS-DownlinkConfig} OPTIONAL, -- Need M
dmrs-DownlinkForPDSCH-MappingTypeB SetupRelease {DMRS-DownlinkConfig}
OPTIONAL, -- Need M
tci-StatesToAddModList SEQUENCE (SIZE(1..maxNrofTCI-States)) OF TCI-State
OPTIONAL, -- Need N
tci-StatesToReleaseList SEQUENCE (SIZE (1..maxNrofTCI-States)) OF TCI-StateId
OPTIONAL, -- Need N
vrb-ToPRB-Interleaver ENUMERATED {n2, n4} OPTIONAL, -- Need S
resourceAllocation ENUMERATED {resourceAllocationType0, resourceAllocationType1,
dynamicSwitch},
pdsch-TimeDomainAllocationList SetupRelease {PDSCH-
TimeDomainResourceAllocationList } OPTIONAL, -- Need M
pdsch-AggregationFactor ENUMERATED {n2, n4, n8} OPTIONAL, -- Need S
rateMatchPatternToAddModList SEQUENCE (SIZE (1..maxNrofRateMatchPatterns)) OF
RateMatchPattern OPTIONAL, -- Need N
rateMatchPatternToReleaseList SEQUENCE (SIZE (1..maxNrofRateMatchPatterns)) OF
RateMatchPatternId OPTIONAL, -- Need N
rateMatchPatternGroup1 RateMatchPatternGroup OPTIONAL, -- Need R
rateMatchPatternGroup2 RateMatchPatternGroup OPTIONAL, -- Need R rbg-Size
ENUMERATED {config1, config2},
mcs-Table-Group1 ENUMERATED {qam256, spare1} OPTIONAL, -- Need S
mcs-Table-Group2 ENUMERATED {qam256, spare1} OPTIONAL, -- Need S
maxNrofCodeWordsScheduledByDCI ENUMERATED {n1, n2} OPTIONAL, -- Need R
prb-BundlingType CHOICE {staticBundling SEQUENCE {bundleSize ENUMERATED
{n4, wideband} OPTIONAL -- Need S}

Example PDSCH-config field descriptions are as follows:
Aperiodic-ZP-CSI-RS-ResourceSetsToAddModList AddMod/Release lists for configuring aperiodically triggered zero-power CSI-RS resource sets;
Each set contains a ZP-CSI-RS-ResourceSetId and the IDs of one or more ZPCSI-RS-Resources (the actual resources are defined in the zp-CSI-RS-ResourceToAddModList);
The network configures the UE with at most 3 aperiodic ZP-CSI-RSResourceSets and it uses only the ZP-CSI-RS-ResourceSetId 1 to 3;
The network triggers a set by indicating its ZP-CSI-RS-ResourceSetId in the DCI payload;
The DCI codepoint ‘01’ triggers the resource set with ZP-CSI-RS-ResourceSetId 1, the DCI codepoint ‘10’ triggers the resource set with ZP-CSI-RS-ResourceSetId 2, and the DCI codepoint ‘11’ triggers the resource set with ZP-CSI-RS-ResourceSetId 3; and
Corresponds to L1 parameter ‘ZP-CSI-RS-ResourceSetConfigList’ (see 38.214, section FFS_Section).

An example PUSCH-config IE is as follows:

-- ASN1START
-- TAG-PUSCH-CONFIG-START
PUSCH-Config:: = SEQUENCE {
dataScramblingIdentityPUSCH INTEGER (0...1023) OPTIONAL, -- Need M
txConfig ENUMERATED {codebook, nonCodebook} OPTIONAL, -- Need S

| | | |
|---|---|---|
| dmrs-UplinkForPUSCH-MappingTypeA | SetupRelease | {DMRS-UplinkConfig} |

OPTIONAL, -- Need M

| | | |
|---|---|---|
| dmrs-UplinkForPUSCH-MappingTypeB | SetupRelease | {DMRS-UplinkConfig} |

OPTIONAL, -- Need M
pusch-PowerControl PUSCH-PowerControl OPTIONAL, -- Need M
frequencyHopping ENUMERATED {mode1, mode2} OPTIONAL, -- Need S
frequencyHoppingOffsetLists SEQUENCE (SIZE (1...4)) OF INTEGER (1..
maxNrofPhysicalResourceBlocks-1) OPTIONAL, -- Need M
resourceAllocation ENUMERATED {resourceAllocationType0, resourceAllocationType1,
dynamicSwitch},

| | | |
|---|---|---|
| pusch-TimeDomainAllocationList | SetupRelease | {PUSCH- |

TimeDomainResourceAllocationList} OPTIONAL, -- Need M
pusch-AggregationFactor ENUMERATED {n2, n4, n8 OPTIONAL, -- Need S
mcs-Table-Group1 ENUMERATED {qam256, spare1} OPTIONAL, -- Need S
mcs-Table-Group2 ENUMERATED {qam256, spare1} OPTIONAL, -- Need S
mcs-TableTransformPrecoder ENUMERATED {qam256, spare1} OPTIONAL, -- Need S
transformPrecoder ENUMERATED {enabled, disabled} OPTIONAL, -- Need S

| | |
|---|---|
| codebookSubset ENUMERATED | {fullyAndPartialAndNonCoherent, |

partialAndNonCoherent, nonCoherent} OPTIONAL, -- Cond codebookBased
maxRank INTEGER (1...4) OPTIONAL, -- Cond codebookBased
rbg-Size ENUMERATED {config2} OPTIONAL, -- Need S
uci-OnPUSCH SetupRelease {UCI-OnPUSCH} OPTIONAL, -- Need M
tp-pi2BPSK ENUMERATED {enabled} OPTIONAL, -- Need S

Example PUSCH-config field descriptions are as follows:
codebookSubset Subset of PMIs addressed by TPMI, where PMIs are those supported by UEs with maximum coherence capabilities Corresponds to L1 parameter ‘ULCodebookSubset’ (see 38.211, section 6.3.1.5);
dataScramblingIdentityPUSCH Identifer used to initalite data scrambling (c_init) for both PUSCHs. Corresponds to L1 parameter ‘Data-scrambling-Identity’ (see 38.211, section 6.3.1.1);
dmrs-UplinkForPUSCH-MappingTypeA DMRS configuration for PUSCH transmissions using PUSCH mapping type A (chosen dynamically via PUSCH-TimeDomainResourceAllocation);
dmrs-UplinkForPUSCH-MappingTypeB DMRS configuration for PUSCH transmissions using PUSCH mapping type B (chosen dynamically via PUSCH-TimeDomainResource Allocation);
frequencyHopping Configures one of two supported frequency hopping mode. If not configured, frequency hopping is not configured. Corresponds to L1 parameter ‘Frequency-hopping-PUSCH’ (see 38.214, section 6);
frequencyHoppingOffsetLists Set of frequency hopping offsets used when frequency hopping is enabled for granted transmission (not msg3) and type 2 Corresponds to L1 parameter ‘Frequency-hoppingoffsets-set’ (see 38.214, section 6.3);
maxRank Subset of PMIs addressed by TRIs from 1 to ULmaxRank. Corresponds to L1 parameter ‘ULmaxRank’ (see 38.211, section 6.3.1.5);
mcs-Table_Group1 Indicates which MCS table the UE shall use for PUSCH inner code without transform precoder Corresponds to L1 parameter ‘MCS-Table-PUSCH’ (see 38.214, section 6.1.4) If the field is absent the UE applies the value 64QAM;
mcs-Table_Group2 Indicates which MCS table the UE shall use for PUSCH outer code without transform precoder Corresponds to L1 parameter ‘MCS-Table-PUSCH’ (see 38.214, section 6.1.4) If the field is absent the UE applies the value 64QAM;
mcs-TableTransformPrecoder Indicates which MCS table the UE shall use for PUSCH with transform precoding Corresponds to L1 parameter ‘MCS-Table-PUSCH-transform-precoding’ (see 38.214, section 6.1.4) If the field is absent the UE applies the value 64QAM;
pusch-AggregationFactor Number of repetitions for data. Corresponds to L1 parameter ‘aggregation-factor-UL’ (see 38.214, section FFS_Section). If the field is absent the UE applies the value 1;
pusch-AllocationList List of time domain allocations for timing of UL assignment to UL data. If configured, the values provided herein override the values received in corresponding PUSCHConfigCommon; and
rbg-Size Selection between config 1 and config 2 for RBG size for PUSCH. When the field is absent the UE applies the value config1. Corresponds to L1 parameter ‘RBG-size-PUSCH’ (see 38.214, section 6.1.2.2.1).

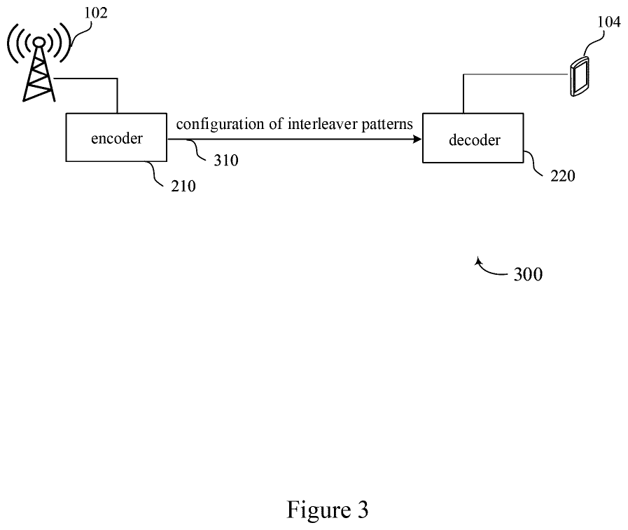

In some embodiments, the system and methods may configure different interleaving patterns with the different concatenated codes. FIG. 3 illustrates an example of signaling 300 a configuration of interleaver patterns between an NE and a UE in accordance with aspects of the present disclosure.

The encoder 210 associated with the base station (the NE 102) may encode one or more data blocks as one or more concatenated codes. A configuration entity may utilize DCI (or other physical layer signaling) and/or RRC signaling to transmit a configuration of interleaver patterns 310, associated with the concatenated codes, to the encoder 210 associated with the NE 102 and/or the decoder 220 associated with the UE 104.

As described herein, each interleaver pattern may be designed to improve distance spectrum properties and reduce low weight codewords. Depending on the choice of the inner and outer codes, the different interleaver patterns may be configured by the transmitter (e.g., the NE 102 and/or the UE 104). The NE 102 may signal the configuration of interleaver patterns 310 via RRC signaling (e.g., within the PDSCH-config and PUSCH-config IEs).

In some cases, the NE 102 may signal one or more interleaving patterns, where each interleaving pattern is associated with an inner interleaver and/or an outer interleaver. In other cases, the same interleaving pattern may be used for one or multiple interleavers (e.g., interleaver blocks) at the transmitter, such as the NE 102. For example, the transmitter may interleave the information bits using a first interleaver and then encode the interleaved (e.g., scrambled) bits using the inner encoder. The output of the first encoder is then interleaved using a second interleaver (or the same interleaving pattern) and fed to an outer encoder for further encoding of the information bits.

In some embodiments, the interleaving patterns and/or puncturing patterns used to enhance code concatenation schemes may be configured as optional fields. For example, such patterns may not be used during good channel conditions, when different code rates of the inner and outer codes lead to high reliability and good BLER performance, and so on. In such cases, the higher layers may enable the transmitter to enable/disable the interleaving and puncturing blocks for certain transport blocks.

In some embodiments, higher layers may signal the code block segmentation, in order to reduce any delays due to the interleaving process or operation. For example, each transport block that exceeds a certain threshold τ may be configured with a code block segmentation parameter. The threshold τ may be determined based on the total length of the transport block, the targeted encoding and decoding delay/latency, the code block associated delays of each of the interleavers, and so on. Based on the value of τ, the NE 102 may determine a number of blocks, or d_{CG}, which corresponds to the number of blocks to be segmented during the segmentation procedure.

As described herein, in some embodiments, the NE 102 may signal a puncturing pattern via RRC signaling (e.g., within the PDSCH-config and the PUSCH-config IEs). For example, with QC-LDPC codes, the puncturing pattern may be applied over the output of one of the LDPC encoders to enhance decoding capabilities (e.g., increasing the girth of the Tanner graph and/or the overall throughput). Thus, the puncturing may be applied to the LDPC encoder with the lowest girth. In some cases, the NE 102 may be configured with one puncturing pattern, which may be enabled/disabled via RRC signaling.

Thus, the signaling procedures may enable the signaling of the concatenated codes, the component codes, the interleaving patterns, and/or the puncturing patterns (e.g., configured by higher layers via RRC signaling in a semi-persistent manner).

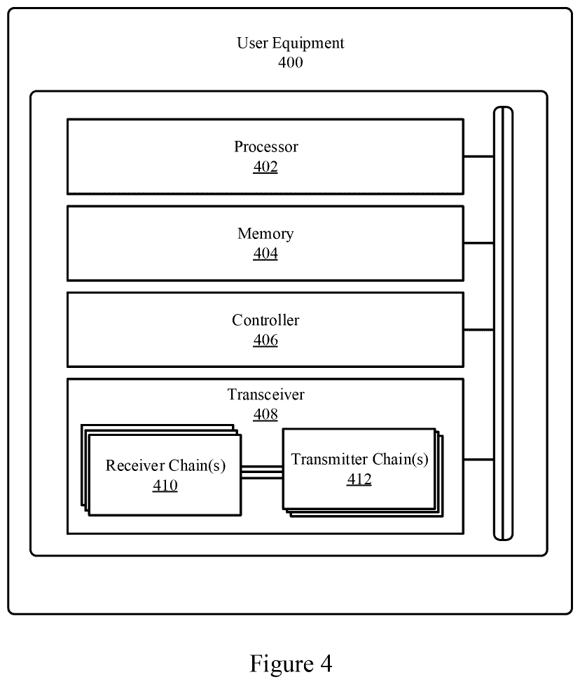

FIG. 4 illustrates an example of a UE 400 in accordance with aspects of the present disclosure. The UE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the UE 400 to perform various functions of the present disclosure.

The memory 404 may include volatile or non-volatile memory. The memory 404 may store computer-readable, computer-executable code including instructions when executed by the processor 402 cause the UE 400 to perform various functions described herein. The code may be stored in a non-transitory computer-readable medium such the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the UE 400 to perform one or more of the functions described herein (e.g., executing, by the processor 402, instructions stored in the memory 404). For example, the processor 402 may support wireless communication at the UE 400 in accordance with examples as disclosed herein. The UE 400 may be configured to support a means for receiving, from a network entity via physical layer or RRC signaling, a configuration of multiple MCSs, wherein the configuration associates each of the multiple MCSs with one or more component codes of multiple concatenated FEC codes, and communicating in accordance with the configuration.

As another example, the UE 400 may be configured to support a means for receiving, from a network entity via RRC signaling, a configuration for one or more interleaver patterns applied to an output of inner codes or an input of the inner codes and outer codes of concatenated FEC codes; and communicating in accordance with the configuration.

The controller 406 may manage input and output signals for the UE 400. The controller 406 may also manage peripherals not integrated into the UE 400. In some implementations, the controller 406 may utilize an operating system such as iOS®, ANDROID®, WINDOWS®, or other operating systems. In some implementations, the controller 406 may be implemented as part of the processor 402.

In some implementations, the UE 400 may include at least one transceiver 408. In some other implementations, the UE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas for receive the signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the processing the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

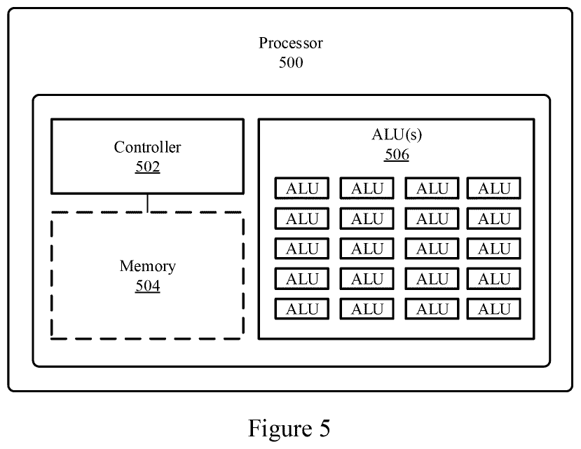

FIG. 5 illustrates an example of a processor 500 in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, which may be, for example, an L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory address of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, arithmetic logic units (ALUs), and other functional units of the processor 500.

The memory 504 may include one or more caches (e.g., memory local to or included in the processor 500 or other memory, such RAM, ROM, DRAM, SDRAM, SRAM, MRAM, flash memory, etc. In some implementations, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, the processor 500, the controller 502, and the memory 504 may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementations, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein.

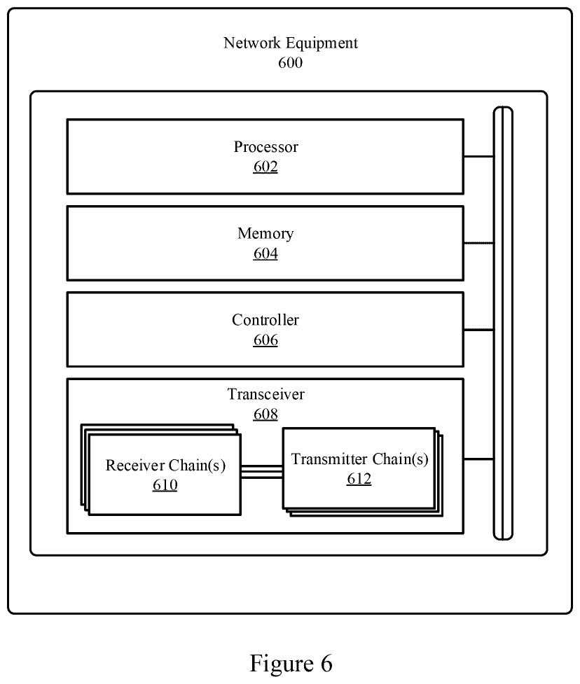

FIG. 6 illustrates an example of a NE 600 in accordance with aspects of the present disclosure. The NE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a CPU, an ASIC, an FPGA, or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the NE 600 to perform various functions of the present disclosure.

The memory 604 may include volatile or non-volatile memory. The memory 604 may store computer-readable, computer-executable code including instructions when executed by the processor 602 cause the NE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the NE 600 to perform one or more of the functions described herein (e.g., executing, by the processor 602, instructions stored in the memory 604). For example, the processor 602 may support wireless communication at the NE 600 in accordance with examples as disclosed herein. The NE 600 may be configured to support a means for generating a configuration of MCSs, wherein the configuration associates each of the multiple MCSs with one or more component codes of multiple concatenated FEC codes and transmitting the configuration to a UE via physical layer or RRC signaling.

As another example, the NE 600 may be configured to support a means for generating a configuration for one or more interleaver patterns applied to an output of inner codes or an input of the inner codes and outer codes of concatenated FEC codes and transmitting the configuration to a UE via RRC signaling.

The controller 606 may manage input and output signals for the NE 600. The controller 606 may also manage peripherals not integrated into the NE 600. In some implementations, the controller 606 may utilize an operating system such as iOS®, ANDROID®, WINDOWS®, or other operating systems. In some implementations, the controller 606 may be implemented as part of the processor 602.

In some implementations, the NE 600 may include at least one transceiver 608. In some other implementations, the NE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receive the signal over the air or wireless medium. The receiver chain 610 may include at least one amplifier (e.g., a low-noise amplifier (LNA)) configured to amplify the received signal. The receiver chain 610 may include at least one demodulator configured to demodulate the receive signal and obtain the transmitted data by reversing the modulation technique applied during transmission of the signal. The receiver chain 610 may include at least one decoder for decoding the processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

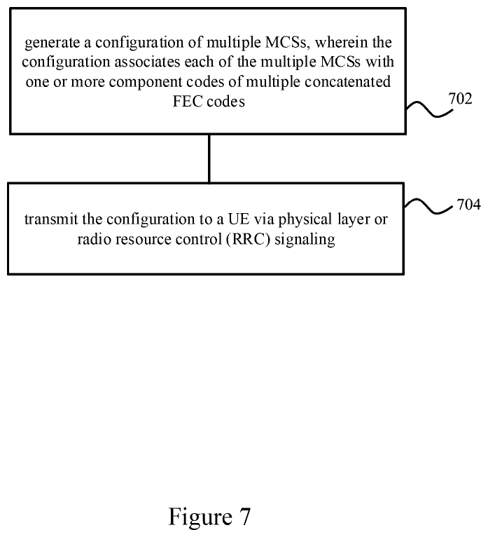

FIG. 7 illustrates a flowchart of a method in accordance with aspects of the present disclosure. The operations of the method may be implemented by an NE as described herein. In some implementations, the NE may execute a set of instructions to control the function elements of the NE to perform the described functions.

At 702, the method may include generating a configuration of MCSs, wherein the configuration associates each of the multiple MCSs with one or more component codes of multiple concatenated FEC codes. The operations of 702 may be performed in accordance with examples as described herein. In some implementations, aspects of the operations of 702 may be performed by an NE described with reference to FIG. 6.

At 704, the method may include transmitting the configuration to a UE via physical layer or RRC signaling. The operations of 704 may be performed in accordance with examples as described herein. In some implementations, aspects of the operations of 704 may be performed by an NE as described with reference to FIG. 6.

It should be noted that the method described herein describes a possible implementation, and that the operations and the steps may be rearranged or otherwise modified and that other implementations are possible.

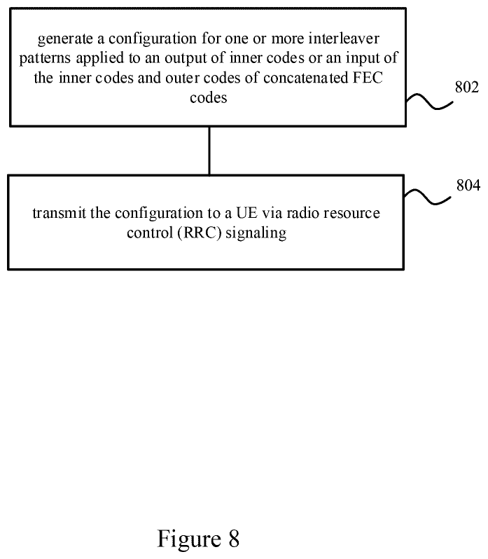

FIG. 8 illustrates a flowchart of a method in accordance with aspects of the present disclosure. The operations of the method may be implemented by an NE as described herein. In some implementations, the NE may execute a set of instructions to control the function elements of the NE to perform the described functions.

At 802, the method may include generating a configuration for one or more interleaver patterns applied to an output of inner codes or an input of the inner codes and outer codes of concatenated FEC codes. The operations of 802 may be performed in accordance with examples as described herein. In some implementations, aspects of the operations of 802 may be performed by an NE as described with reference to FIG. 6.

At 804, the method may include transmitting the configuration to a UE via RRC signaling. The operations of 804 may be performed in accordance with examples as described herein. In some implementations, aspects of the operations of 804 may be performed by an NE as described with reference to FIG. 6.

It should be noted that the method described herein describes a possible implementation, and that the operations and the steps may be rearranged or otherwise modified and that other implementations are possible.

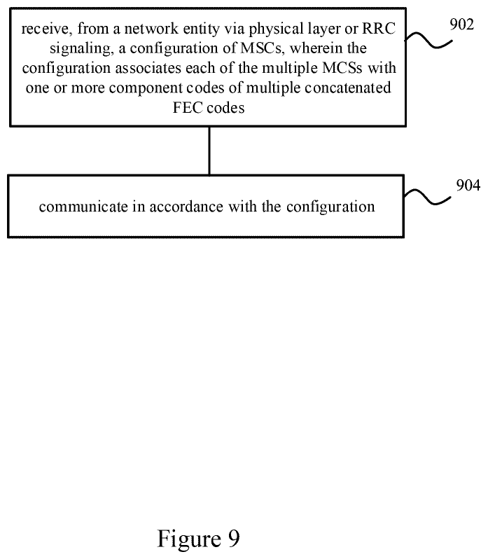

FIG. 9 illustrates a flowchart of a method in accordance with aspects of the present disclosure. The operations of the method may be implemented by a UE as described herein. In some implementations, the UE may execute a set of instructions to control the function elements of the UE to perform the described functions.

At 902, the method may include receiving, from a network entity via physical layer or RRC signaling, a configuration of multiple MCSs, wherein the configuration associates each of the multiple MCSs with one or more component codes of multiple concatenated FEC codes. The operations of 902 may be performed in accordance with examples as described herein. In some implementations, aspects of the operations of 902 may be performed by a UE as described with reference to FIG. 4.

At 904, the method may include communicating in accordance with the configuration. The operations of 904 may be performed in accordance with examples as described herein. In some implementations, aspects of the operations of 904 may be performed by a UE as described with reference to FIG. 4.

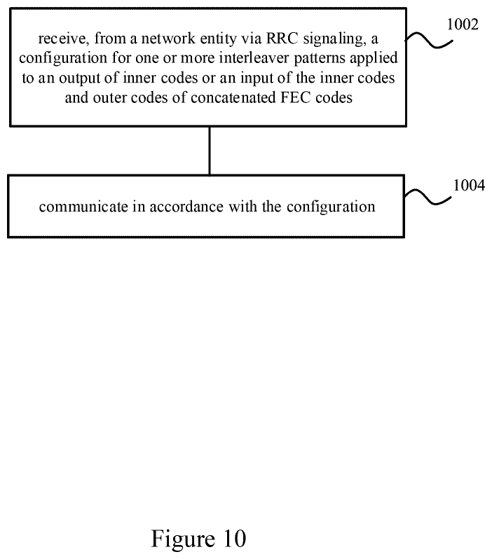

FIG. 10 illustrates a flowchart of a method in accordance with aspects of the present disclosure. The operations of the method may be implemented by a UE as described herein. In some implementations, the UE may execute a set of instructions to control the function elements of the UE to perform the described functions.

At 1002, the method may include receiving, from a network entity via RRC signaling, a configuration for one or more interleaver patterns applied to an output of inner codes or an input of the inner codes and outer codes of concatenated FEC codes. The operations of 1002 may be performed in accordance with examples as described herein. In some implementations, aspects of the operations of 1002 may be performed by a UE as described with reference to FIG. 4.

At 1004, the method may include communicating in accordance with the configuration. The operations of 1004 may be performed in accordance with examples as described herein. In some implementations, aspects of the operations of 1004 may be performed by a UE as described with reference to FIG. 4.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
at least one memory; and
at least one processor coupled with the at least one memory and configured to cause the network entity to:
generate a configuration of multiple modulation and coding schemes (MCSs),
wherein the configuration associates each of the multiple MCSs with one or more component codes of multiple concatenated forward error correction (FEC) codes; and
transmit the configuration to a user equipment (UE) via physical layer or radio resource control (RRC) signaling.

2. The network entity of claim 1, wherein the at least one processor is further configured to cause the network entity to:
define, for the multiple concatenated FEC codes, a first MCS table for an inner code and a second MCS table for an outer code.

3. The network entity of claim 2, wherein the at least one processor is further configured to cause the network entity to select the first MCS table and the second MCS table based on channel conditions of a network associated with the network entity, spectral efficiency for the network, or target requirements for a service support by the network.

4. The network entity of claim 1, wherein the at least one processor is configured to cause the network entity to transmit the configuration of multiple MCSs to the UE via separate downlink control information (DCI) formats.

5. The network entity of claim 4, wherein a DCI format comprises additional MCS fields, including:
a first additional MCS field associated with inner codes of one or more channel codes; and
a second additional MCS field associated with outer codes of the one or more channel codes.

6. The network entity of claim 4, wherein a DCI format comprises an MCS field that is extended to indicate a code rate associated with an inner code of the one or more channel codes and a code rate associated with an outer code of the one or more channel codes.

7. The network entity of claim 4, wherein the separate DCI formats include modulation and coding information for the multiple concatenated FEC codes.

8. The network entity of claim 4, wherein the separate DCI formats include:
a first DCI format associated with inner codes of the one or more channel codes; and
a second DCI format associated with outer codes of the one or more channel codes.

9. The network entity of claim 1, wherein the at least one processor is configured to cause the network entity to transmit the configuration to the UE via the RRC signaling.

10. The network entity of claim 9, wherein the at least one processor is configured to cause the network entity to transmit, via physical downlink shared channel (PDSCH)-config and physical uplink shared channel scheduling (PUSCH)-config information elements (IEs) of the RRC signaling, the multiple concatenated FEC codes to the UE in a semi-static manner.

11. The network entity of claim 9, wherein different radio network temporary identifiers (RNTIs) are associated with different MCSs of the configuration.

12. The network entity of claim 9, wherein the at least one processor is configured to cause the network entity to transmit to the UE, via the RRC signaling, one or more interleaving patterns applied to an output of the multiple concatenated FEC codes.

13. The network entity of claim 9, wherein the at least one processor is configured to cause the network entity to transmit, via physical downlink shared channel (PDSCH)-config and physical uplink shared channel scheduling (PUSCH)-config information elements (IEs) of the RRC signaling, puncturing parameters associated with the multiple concatenated FEC codes.

14. The network entity of claim 1, wherein the multiple concatenated FEC codes include quasi-cyclic, low-density, parity-check (QS-LDPC) codes, polar codes, Bose-Chaudhuri-Hocquenghem (BCH) codes, or combinations thereof.

15. A network entity for wireless communication, comprising:
at least one memory; and
at least one processor coupled with the at least one memory and configured to cause the network entity to:
generate a configuration for one or more interleaver patterns applied to an output of inner codes or an input of the inner codes and outer codes of concatenated forward error correction (FEC) codes; and
transmit the configuration to a user equipment (UE) via radio resource control (RRC) signaling.

16. The network entity of claim 15, wherein the at least one processor is further configured to cause the network entity to generate the configuration to indicate one or more puncturing procedures applied to the inner codes or the outer codes of the concatenated FEC codes.

17. The network entity of claim 15, wherein the at least one processor is configured to cause the network entity to transmit the configuration to the UE via physical downlink shared channel (PDSCH)-config and physical uplink shared channel scheduling (PUSCH)-config information elements (IEs) of the RRC signaling.

18. A user equipment (UE) for wireless communication, comprising:
at least one memory; and
at least one processor coupled with the at least one memory and configured to cause the UE to:
receive, from a network entity via physical layer or radio resource control (RRC) signaling, a configuration of multiple modulation and coding schemes (MCSs), wherein the configuration associates each of the multiple MCSs with one or more component codes of multiple concatenated forward error correction (FEC) codes; and
communicate in accordance with the configuration.

19. The UE of claim 18, wherein the at least one processor is configured to cause the UE to receive the configuration via separate downlink control information (DCI) formats.

20. A user equipment (UE) for wireless communication, comprising:
at least one memory; and
at least one processor coupled with the at least one memory and configured to cause the UE to:
receive, from a network entity via radio resource control (RRC) signaling, a configuration for one or more interleaver patterns applied to an output of inner codes or an input of the inner codes and outer codes of concatenated forward error correction (FEC) codes; and
communicate in accordance with the configuration.
